(19) United States
(12) Patent Application Publication
(10) Pub. No.: US 2016/0006715 A1
(43) Pub. Date: Jan. 7, 2016

(54) SYSTEM AND METHOD FOR OBTAINING ELECTRONIC CONSENT

(71) Applicant: Don B. Lee, New York, NY (US)

(72) Inventor: Don B. Lee, New York, NY (US)

(21) Appl. No.: 14/322,445

(22) Filed: Jul. 2, 2014

(51) Int. Cl. H04L 29/06; H04L 29/08; H04W 12/06

(52) U.S. Cl. CPC H04L 63/083; H04L 63/062; H04W 12/06; H04L 67/142

(57) ABSTRACT

A system for obtaining electronic consent whereby a user provides consent through a mobile device. In the system the mobile device is electronically connected to a central computing system. The central computing system generates the consent forms that are transmitted over the communication link to the mobile device. After inputting a unique password, the user is then able to review and attest to the documents provided on the mobile device. Upon completion, the documents are then transmitted back to the central computing device where they are reviewed for completeness and accuracy. The authorized documents are then filed in a secure electronic file. The mobile device is then purged of all personal data in order to maintain the integrity of the personal information.

### BACKGROUND

There are many processes that require a user to authorize or grant consent for an action. The process for approval requires that an individual is made aware of key information and acknowledges that he or she understands the information that has been presented. The acknowledgement of understanding, usually in the form of a signature or the affixation of an identifying mark that is unique to the individual, is then documented and maintained for the record.

Authorization and consent forms, similarly to contract agreements, provide important information regarding an act or service and allow an individual to acknowledge and agree to the terms provided. When an individual affixes his or her signature to a consent form, he or she acknowledges that they have read the information and authorize the act or service described in the form, subject to any identified conditions. Thus obtaining authorization for an action and maintaining sufficient record of the consent is important to document the understanding of the parties and to protect against false claims and assertions misunderstandings.

In the past, many consent documents were processed manually with paper forms that required handwritten signatures attesting consent. This process created many challenges. Specifically, maintaining consent forms for a variety of processes could yield volumes of paper to be organized and filed. Additionally, in a multilingual society, it is also important to ensure that the individual is able to receive instructions or information in a form that ensures that the user understands the documents to be completed and signed. Thus, maintaining paper consent documents in multiple languages can create an even greater burden.

Even in cases where forms are printed on an as-needed basis, there is still an issue with storage and filing. Particularly, in many cases manual forms are stored in traditional storage cabinets. Those cabinets not only take up a significant amount of space, but human error could also lead to misfiled or lost paperwork. Furthermore, even when digital storage is available, the paper documents must be stored temporarily or scanned immediately and then destroyed. Regardless of whether paper forms are stored temporarily or long-term, many consent forms may contain personal or private information that should be protected and secured at all times. Manual processing leaves personal information open to the possibility of being mishandled. Paper forms may be mislaid or even removed from a file and thus leave an individual's personal information vulnerable to criminal activity such as identity theft or other misuse.

Protecting personal information is especially critical when it comes to medical records. In hospitals and clinical settings, capturing patient information and securing consent from a patient is a routine part of the patient registration and treatment process. With few exceptions, the patient must provide consent prior to any medical services being rendered. In completing intake and consent forms, the process can require that a person read and review lengthy documents and attest understanding. This process can be complicated if the documents are not offered in the patient's native language. A lack of understanding often results in forms that are incomplete or improperly signed, wasted paper, and an overall loss of time and efficiency in the medical treatment process. Furthermore, medical consent forms often contain personal information that should be protected in accordance with the law.

Currently, there is no system that allows for customized consent forms to be generated and offered to an individual electronically, wherein the individual can complete the forms and attest consent as required, and electronically submit the forms for electronic filing, ensuring that the individual's personal information remains protected throughout the authorization process. Furthermore, there is no system that provides notification for documents requiring a witness or additional signatures. Additionally, there is no system that provides that personal or otherwise user sensitive data is deleted from any remote device once the consent is received for storage on a secure computing system.

New systems and methods for securing consent are needed. Specifically, systems and methods that can be used to obtain the consent of an individual through electronic processing such that the personal information of an individual is secured and protected. The consent process can be customized to include only the documentation that is necessary for the individual to authorize and can be offered in the language that the individual selects. Further all personal or sensitive data is purged from a remote device once consent has been provided. The new systems and methods allow for faster processing with fewer mistakes and greater accuracy as well as better protection for personal user data.

### SUMMARY

New systems and methods for obtaining electronic authorization are provided. One advantage of the present system is to provide a centralized computing system capable of electronically linking to a plurality of electronic mobile devices. The centralized computing system is able to transmit and receive data between the computer and each of the electronic mobile computing devices. In one embodiment, the data is transmitted via a secure wireless network that ensures that personal information remains protected. In one embodiment the secure data transmission involves data encryption methods.

Another advantage of the electronic consent system is the ability to incorporate computer readable instructions, such a software program, such that data can be shared between the central computing system and each of the mobile devices. In one embodiment, software code or logic will allow documents to be readable and editable from the central computing system as well as on a mobile device. In some cases, the computer readable instructions may be pre-loaded on each system when the computer systems are assembled (e.g., special order systems built to specification including software and applications) or it may be manually loaded using for example, installation disk, CDs, or other connectable data drives (e.g., flash drives). Alternatively, the software is downloadable via an online Internet source. Software upgrades and updates for maintaining or enhancing the capabilities and functions of the systems and methods may also be available for download through an Internet website.

Another advantage of the electronic consent system is the ability to customize the data that is shared between the central computing system and each of the mobile devices. Unique data and consent forms can be pushed or transmitted from the centralized computing system to each of the mobile devices. The specific forms that are transmitted to each of the mobile devices depend on the authorization that is requested by the individual using the mobile device. In various embodiments, the documents transmitted from the central computing device to one of the plurality of mobile devices would be similar to those transmitted to another mobile device. In other embodiments, the documents transmitted to a mobile device would be different in each of the mobile devices. In each case, the documentation transmitted from the central computing system to each of the mobile devices would be specific to the authorization forms that the individual user is required to complete. In various embodiments, the forms will contain personal information specific to each user. In some embodiments, the forms contain pre-filled information specific to the individual user and in some embodiments, the user can input personal information through the mobile computing device.

Another advantage of the system provides that the mobile device is enabled with security features such that no personal information is retained on the mobile device. Each time personal information is transmitted from the mobile device back to the central computing system, the mobile device is purged of all personal information pertaining to the individual user. In one embodiment, the software and security settings will comply with at least the minimum standards for maintaining personal data such as medical records. In yet another exemplary embodiment, the mobile device is further equipped with safety settings such that any perceived breach in security results in the mobile device being wiped clean of data, such as personal information pertaining to the individual user.

In one embodiment the method of obtaining electronic consent comprises generating unique documents or authorization forms for each individual user. In various embodiments the forms are electronically transmitted to a mobile device. The individual whose consent is sought is able to securely access the consent forms via the mobile device. The individual is able to review the documents and affix his or her electronic signature to each of the required forms. Upon providing consent, the forms are securely transmitted back to the central computer for review and storage. In one embodiment completed forms are stored remotely via a secure server system or other secure electronic data storage means. Additional embodiments provide that the completed forms are accessible by authorized personnel.

In the following detailed description of the present disclosure, reference is made to the accompanying drawings that form a part hereof, and in which is shown by way of illustration how examples of the disclosure may be practiced. Additional features and advantages of various embodiments will be set forth in part in the description that follows, and in part will be apparent from the description, or may be learned by practice of various embodiments. These examples are described in sufficient detail to enable those of ordinary skill in the art to practice the examples of this disclosure, and it is to be understood that other examples may be utilized and that process and/or structural changes may be made without departing from the scope of the present disclosure. The objectives and other advantages of various embodiments will be realized and attained by means of the elements and combinations particularly pointed out in the description and appended claims.

### BRIEF DESCRIPTION OF THE DRAWINGS

In part, other aspects, features, benefits and advantages of the embodiments will be apparent with regard to the following description, appended claims and accompanying drawings where:

FIG. 1 illustrates a basic overview of the electronic consent system. In the illustrated embodiment, a plurality of mobile devices are shown to connect with the central computing system. This illustrated embodiment is not intended to limit the number or type of devices that are operable with this system.

FIG. 1A illustrates a basic overview of the electronic consent system of FIG. 1. In the illustrated embodiment, the central computing system is in communication with a patient's electronic medical records, which can be accessed from electronic medical records work stations.

FIG. 2 illustrates a basic computer architecture including basic components of exemplary computing devices.

FIG. 3 illustrates an embodiment of the system architecture that incorporates computer readable instructions that allow customized user forms to be generated through a central computing device and mapped to mobile devices.

FIG. 3A illustrates an embodiment of the system architecture of FIG. 3. In the illustrated embodiment, the form engine is in communication with data storage and is configured to access a patient's electronic medical records through web services.

FIG. 4 illustrates an exemplary form type that the user may be given to provide electronic consent through mobile device.

FIG. 5 illustrates an embodiment of the method of obtaining consent where documents are transmitted from a central computing system to an end user on a mobile device, and upon review and authorization, the documents are returned to the central computing system.

FIG. 5A illustrates an embodiment of the method of obtaining consent of FIG. 5. In this illustrated embodiment, the method further comprises validating the user.

FIG. 6 illustrates an embodiment of a security module that can be implemented to maintain the security of personal data.

FIG. 6A illustrates an embodiment of a security module of FIG. 6.

FIG. 7 illustrates an embodiment of a login screen where a user is able to enter his or her registered personal credentials in order to securely access his or her personal document queue.

FIG. 8 illustrates an exemplary embodiment of a process flow in a health care environment.

FIG. 8A illustrates an exemplary embodiment of a process flow in a health care environment of FIG. 8.

It is to be understood that the figures are not drawn to scale. Further, the relation between objects in a figure may not be to scale, and may in fact have a reverse relationship as to size. The figures are intended to bring understanding and clarity to the structure of each object shown, and thus, some features may be exaggerated in order to illustrate a specific feature of a structure.

### DETAILED DESCRIPTION

For the purposes of this specification and appended claims, unless otherwise indicated, all numbers expressing quantities and other numerical values used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention.

It is noted that, as used in this specification and the appended claims, the singular forms “a,” “an,” and “the,” include plural referents unless expressly and unequivocally limited to one referent. Thus, for example, reference to “a mobile device” includes one, two, three or more mobile devices.

Reference will now be made in detail to certain embodiments of the systems and methods provided in this application, examples of which are illustrated in the accompanying drawings. While the systems and methods will be described in conjunction with the illustrated embodiments, it will be understood that they are not intended to be limited to those embodiments. On the contrary, the systems and methods are intended to cover all alternatives, modifications, and equivalents as defined by the description and appended claims.

New systems and methods, which can more easily and efficiently allow a user to access a customized set of form documents and attest consent and authorization are provided. In some embodiments, there is a system for obtaining electronic consent from a user, the system comprising: a central computing system comprising logic for executing computer readable instruction to cause the central computing system to send and receive electronic data, the central computing system comprising a processing unit, a memory component, a data storage component, a visual display and a means for data input; a mobile computing device comprising logic for executing computer readable instruction to cause the mobile computing device to send and receive electronic data to and from the central computing system, the mobile device comprising a visual display and a means for data input including a user's signature; and a purging module of the central computing system and/or mobile computing device comprising logic for purging some or all data from the mobile device on the user signing the mobile device and transmitting some or all data from the mobile device to the central computing system. In this way, after the mobile device is electronically signed, (e.g., by digital signature, certificate, etc.), some or all data is purged from the mobile device by the user transmitting the signature to the central computing system. In some embodiments, all data from the mobile device is purged from the device except the unique identifier that allows the central computing system to send new data to the mobile device.

In some embodiments, there is a mobile computing device for obtaining electronic consent, the mobile computing device comprising logic for executing computer readable instruction to cause the mobile computing device to send and receive electronic data to and from a central computing system, the mobile device comprising a visual display and a means for data input including a user's signature; and a purging module of the mobile computing device comprising logic for purging some or all data from the mobile device on the user signing the mobile device and transmitting some or all data from the mobile device to the central computing system.

In some embodiments, there is a central computing system for obtaining electronic consent, the central computing system comprising logic for executing computer readable instruction to cause the central computing system to send and receive electronic data to and from a mobile computing device, the central computing system comprising a visual display and a means for data input; and a purging module comprising logic for purging some or all data from the mobile device on the user signing the mobile device and transmitting some or all data from the mobile device to the central computing system.

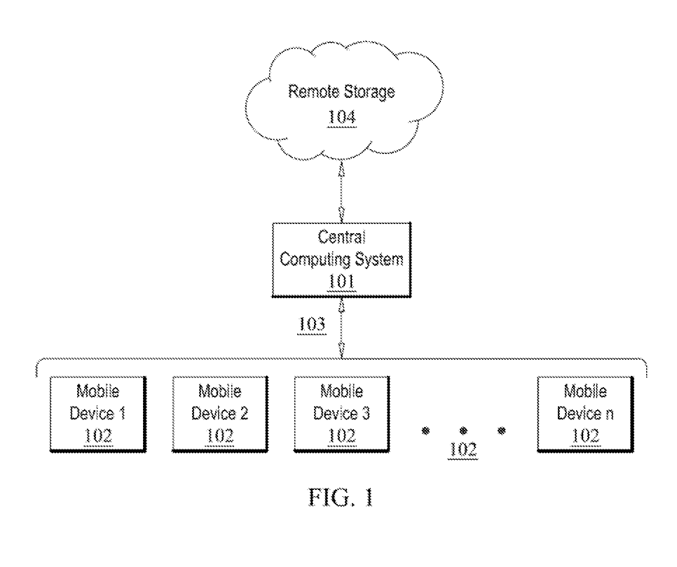

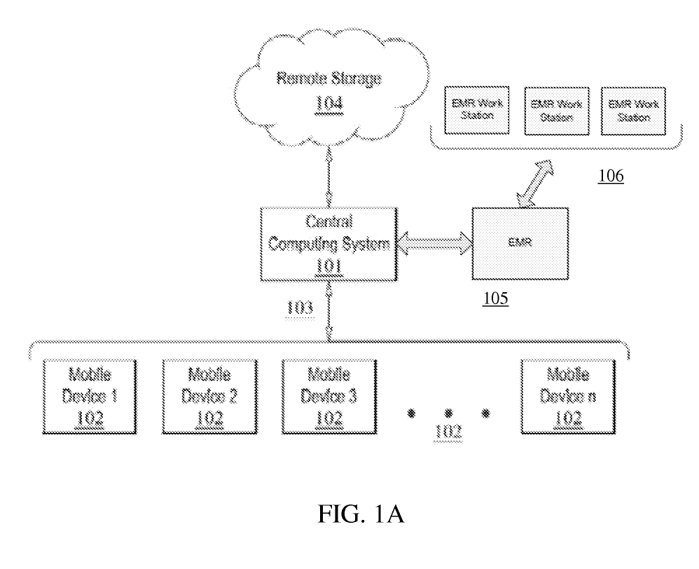

The electronic consent system in FIG. 1 comprises a central computing system (101) electronically coupled to various devices. In various embodiments the computing system comprises a user-operated terminal, including a visual display, a means for data input as well as a means for processing data transactions. The central computing system may comprise an internal data storage component for storing electronic data files and records. In one embodiment, the system may also comprise external storage components such that data can be stored independently of the central computing system (104). External storage may be onsite via any data storage means, such as an onsite server or data may also be stored offsite through a remote cloud storage means.

In one embodiment the central computing system is electronically connected (103) to a data storage means as well as to a plurality of mobile computing devices (102). Each of the mobile devices will be equipped with a screen for providing visual display of data and an input means to input data into the mobile device. In various embodiments, exemplary mobile devices may include portable computing systems such as a laptop computer, a tablet computer, or any type of portable device configurable to provide a visual display to the user, accept user input, and process data. In some embodiments, the mobile device will allow data entry via means such as a keypad (real or virtual), touch screen selection (e.g., touching screen to highlight choice), manual screen input (e.g., writing on the screen with appropriate instrument such as a stylus), or voice capture (e.g., either convertible to text or stored as audio file). In some embodiments, the mobile device will include audio output means such as built-in speakers or a standard audio socket that receives a jack to allow speakers such as headphones or earphones to connect to the mobile device and to project sound.

In one embodiment, the central computing system and each of the plurality of mobile computing devices are equipped with compatible computer readable logic or instructions such as a software program to execute a variety of data processing modules and commands. In some embodiments the computer readable instructions allow data to be shared between the central computing system and each of the mobile devices. Employing compatible software programs across devices will allow forms and documents to be consistently viewed and edited in the central computing system as well as in any of the plurality of mobile devices.

In various embodiments, the central computing system and the mobile devices will contain computer readable instructions such that the systems are capable of web-based communications. In various embodiments, data entered using the central computing system may be accessed via a secure web interface available using the mobile device and data entered using the mobile device may be accessed via a secure web interface available on the central computing system.

In one embodiment, as shown in FIG. 1A, the central computing system (101) is in communication with a patient's electronic medical records (EMR) (105) which can be accessed from a plurality EMR work stations (106). In this way, a timing module in the central computing system 101 can transmit and receive data to and from the electronic medical record computer (EMR) 105 in a certain period of time and this data can be sent and received to and from the plurality of electronic work stations 106. In this way, if there is a delay in completing the consent form of a slow first user and the second user is already done with the consent form, the central computing system 101 can bypass the slow first user and send data to and from the EMR 105 to the work station 106, so that there is no bottle neck caused by the slow first user.

For example, if mobile device user 1 in 102 is slow at completing the data in the paperless consent form, the mobile device user 2, who is a fast user and has completed the data, can transmit the data to the central computing system, where the timing module will keep track of time for submission. Central computing system 101 can send and receive data from mobile device of user 2, because this user has completed the consent form first, to EMR 105 and then to EMR work stations so that there is no delay caused by mobile device user 1. This can be done by a timing module in central computing system 101, EMR 105, and/or in the EMR work station 106. An alerts generator can transmit and alert to the mobile device 102 for device 1, after a certain time, indicating that the electronic form has not been completed.

In some embodiments, the mobile device (e.g., IPAD, tablet, MS Surface, Android, etc.) can automatically purge any existing data should the electronic form not be completed within a certain period of time. Thus the timing module and purging module can work together to purge the data. The timing module and/or purging module can be in the central computing system 101, in the EMR 105, in the EMR work station 106, and/or in the mobile device 102.

In some embodiments, the mobile device 102 does not have the capability to store and medical record data so that if the device is lost or stolen, there will be no data storage capability. In this embodiment, the data storage is a remote data storage 104 and not on the actual device itself. In some embodiments, only HTML data is stored on the device and not PDF data.

In some embodiments, the EMR work station 106 comprises a monitoring module to monitor the mobile devices 102 to insure the electronic forms are completed within a certain period of time or allow one fast user to bypass a slower user.

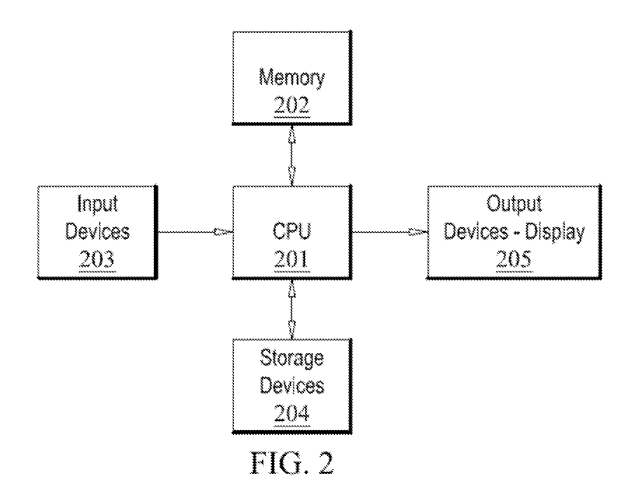

FIG. 2 illustrates an exemplary model of a central computing system. Basic components of computing systems are understood and this figure shows typical components required for providing computing functionality. Other models and iterations of a computer system would also be understood and deemed acceptable within the spirit of this application. The central computing system comprises a central processing unit (“CPU”) (201) for processing instructions and mapping interactions between components. The CPU is coupled with memory (202) enabling the processor to execute instructions and commands. In exemplary embodiments, memory such as random access memory (RAM), magnetic memory such as a hard disk, floppy disk, and/or tape memory, a solid state drive (SSD), flash memory, phase change memory, etc are acceptable. The central computing system also comprises data storage devices (204). In some embodiments storage is internal to the system via a hard disk or removable via CD/DVD or other portable memory drives (e.g., flash storage). The system may also be electronically connected to external storage such as a server system or remote cloud storage. In various embodiments the central computing system also comprises an input means (203) such as a keyboard (real or virtual) a mouse, a stylus, or any other tool for communicating information to the system. The central computing system also comprises an output device such as a visual display (205) in order to project information from the system to a user.

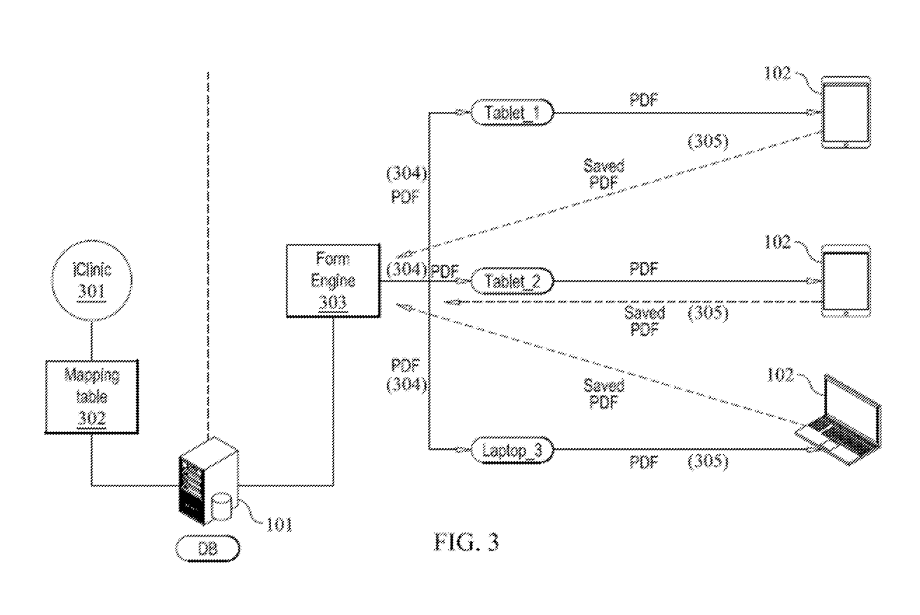

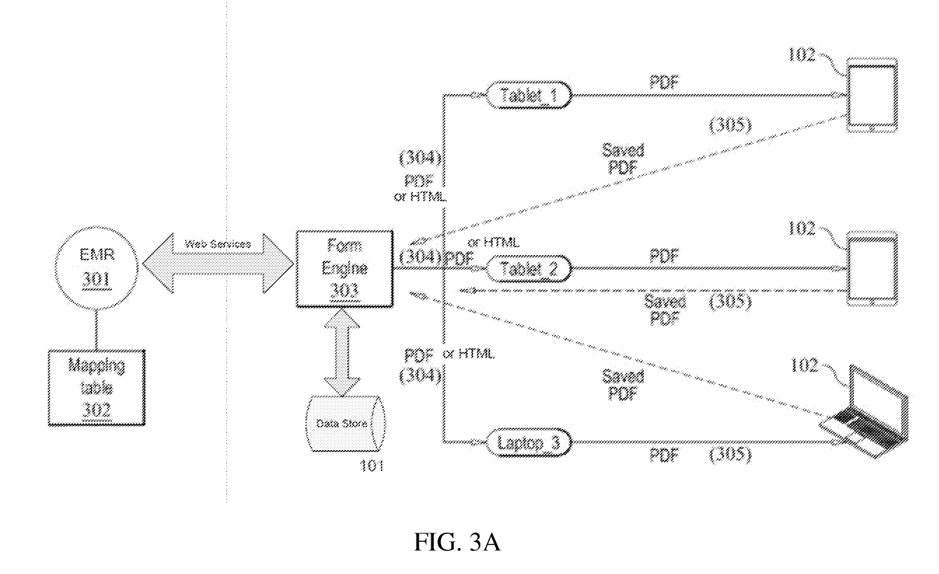

In one embodiment, forms or documents requiring attestation of consent will be generated via for example, a form generating software module provided on the central computing system. A unique combination of forms and documents can be customized for each individual user. The combination of forms represents only the forms that require a particular user's consent. Customizing the authorization forms help to simplify and expedite the consent process. In the embodiment shown in FIG. 3, exemplary software such as iClinic 12.1® (301) may be provided on a computing system (101). The exemplary software allows the personal information to be mapped (302) to individual medical records stored in a database, which could either be a component of the central computing system (as shown) or a remote storage unit. The form creation module (303) of the software then creates the appropriately formatted forms to be sent to each individual user based on the user's mobile device.

In some embodiments, parts of the document are static, i.e., they are only readable while other parts of the document allow the user to edit certain fields. Specifically, fields may be edited to include the user's personal information or personal answers to questions presented in the document. The forms and documents may be such that they can be read and edited via the central computing system or the mobile device. The embodiment shown provides that the documents are created in a portable document format, such as Adobe® PDF, and then transmitted via an electronic communication means (304) to a mobile device. After the user has completed the forms, the user can submit the PDF, including user's electronic consent, back to a central computing system for review and/or storage (305).

In one embodiment, the method of obtaining consent comprises providing custom forms to the user. Specifically, a unique set of forms can be generated that are specific to the consent sought from a particular user. The forms and documents that are generated may require the user to input all personal data whereas other embodiments may allow some personal data to be pre-populated into the form from a variety of sources. In some exemplary embodiments, some personal user data may be pre-filled into the form based on personal information stored in a secure database such as a user's electronic file (e.g., Patient Electronic Medical Record) or other previously completed data forms. In several embodiments, the forms may comprise a combination of pre-populated information and fill-in blanks for the patient to enter specified information.

In the exemplary embodiment illustrated and described in FIG. 3, the PDF type format provides that the document appearance is consistent between viewing devices. Other file formats that allow the file to be viewed and edited are also considered. In the present embodiment, only certain fields of the document may be modified, while other text including instructions and questions to be answered are static and cannot be edited.

In one embodiment, as shown in FIG. 3A, the form engine is in communication with data storage (101) and is configured to access a patient's electronic medical records (EMR) (301) through web services. In some embodiments, only HTML data is stored on the device and not PDF data. The HTML data can be used to generate a time and date stamp on the PDF form that is transmitted to and from and stored on form engine module 303, where it can be stored on a separate data storage module 101. The medical record data can be transmitted to and from the EMR module or computer 301. In this way, the engine form generator 303 can generate the sufficient number of forms and transmit and receive data including the HTML data from the mobile devices (tablet, surface, labtop, IPAD, etc.) so that there is no bottle neck in the system due to the number of users, or slow users, or insufficient number of electronic forms generated. Communication between the form engine 303 and the electronic medical record (EMR) 301 can be accomplished via the web.

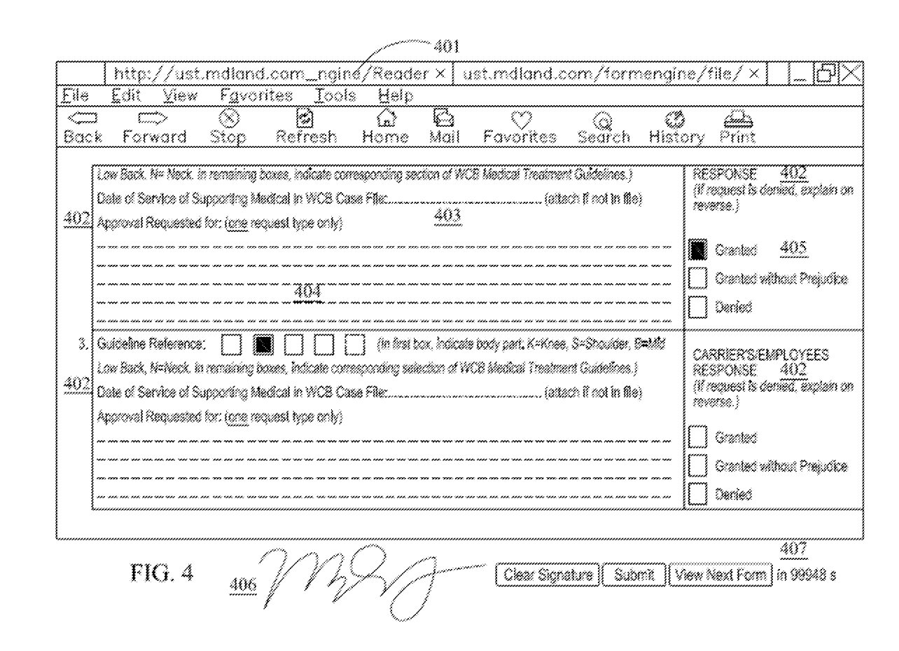

In an exemplary form shown in FIG. 4, the form is viewable via a web-based interface (401). The document provides blocks of static text in the form of questions that the user cannot modify (402). In the present embodiment, user identification information such as name and file number may be manually input into the forms (403), while in other embodiments, that exemplary information may be pre-filled from a database and may or may not be editable by the user. Exemplary embodiments may provide the form includes blank lines (404) or text boxes to denote the parameters for user input. In various embodiments standard word processing editing tools (e.g., spell check, cut, copy, paste, etc.) may be provided for editing user text input. In other embodiments of forms, other means of user input are also possible. In some embodiments, the forms provide check boxes that allow a user to select between options by clicking a radial button, a check box, or another means of highlighting or indicating a user selection (405). In some embodiments, a user may be required to “check a box” to indicate that the user has read or otherwise reviewed certain information. Additionally, in various embodiments, forms will provide a place for the user to provide consent via signature or input of another form of acceptable attestation of consent (e.g., PIN) (406). In some embodiments, each form may also include a several options that allow a user to for example, return to a previous screen, move to the next form in the queue or complete and submit the documents if the user has reached the end of the document queue (407).

In various embodiments, a plurality of forms or documents may be sent to a mobile device to obtain a user's consent or authorization. In some embodiments the forms may be documents related to a single purpose (e.g., consent for a specific medical procedure such as colonoscopy). In other embodiments the forms could be related to multiple purposes that require the user's consent (e.g., consent for a colonoscopy, blood work, and an EKG).

Various embodiments of the forms provide that personal information such as name, address and phone number are collected from the user or verified by the user. In other embodiments, other information that may be used to uniquely identify the user may be provided or requested. For example, the user's social security number, a case number or file number assigned to the user, insurance information, credit card information, or any other information that is linked to a user's identity may be required. Still other exemplary embodiments of forms may provide other sensitive information pertaining to specific user. For example, the form may provide information such as employment history, criminal background, or in a medical context, the form may provide information specific to the user's medical treatment or regarding the user's medical history.

In various embodiments the forms provided may include any documents that require a user to read instructions or directives or other information and provide acknowledgment. Some embodiments provide that forms allow the user to input information into a document and acknowledge information provided in a document. Exemplary forms types may include but are not limited to medical patient intake, medical treatment consent, surgery authorization, acknowledgment of risk of procedure or process, post-procedure instructions, a “do not resuscitate” order, insurance approval documents, billing statements, payment authorizations, contractual agreements, etc.

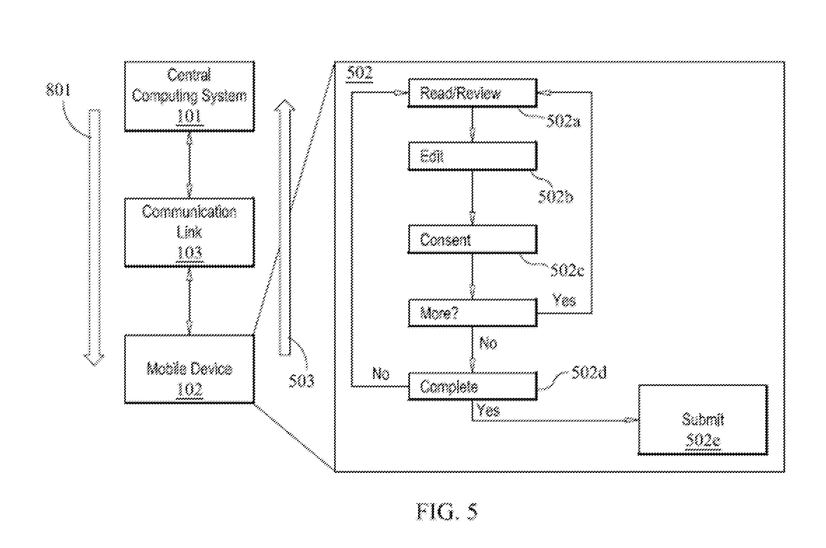

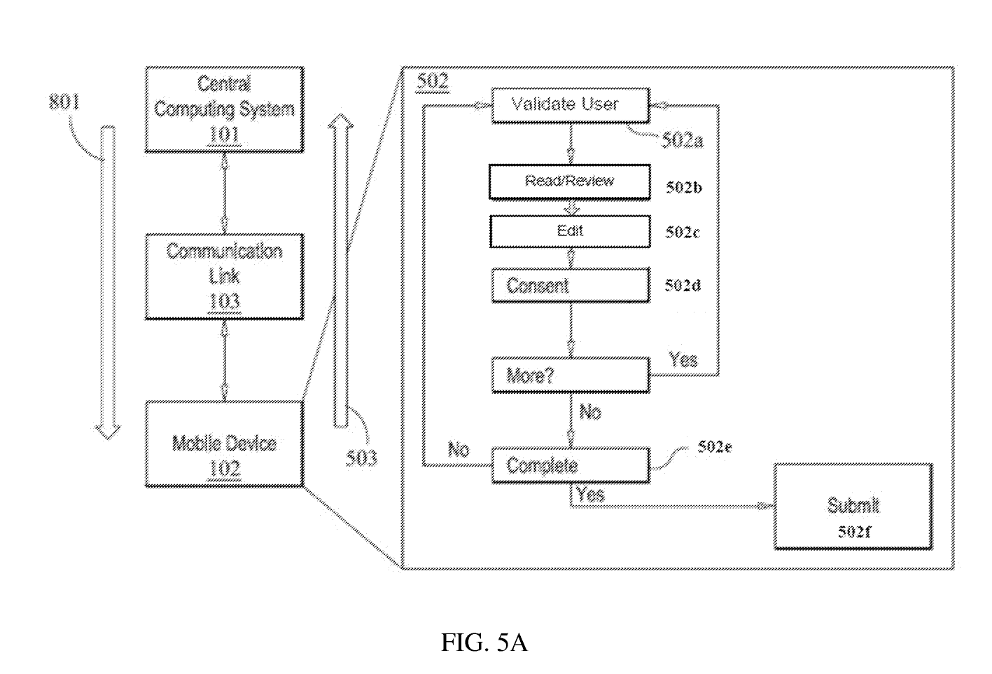

FIG. 5 illustrates various embodiments of a method of obtaining informed user consent. The selected combination of forms and documents are transmitted (501) to one of the plurality of mobile devices connected to the central computing system. In some embodiments, the electronic communication means (103) is a network-based system such as a secure wireless local area network (WLAN). In exemplary embodiments the communication network is a Wi-Fi connection, Bluetooth type connection, or any other available connection that will support the secure transmission of data between devices. In various embodiments the range of the wireless transmission signal will provide physical limitations to the location of the connected mobile devices.

A wireless communication system operating in accordance with the widely used 802.11 WLAN protocol is used herein as a primary example of a WLAN. An understanding of the 802.11 protocol (Direct Sequence Spread Spectrum, or DSSS), which is publicly available from IEEE (Institute of Electrical and Electronics Engineers), is assumed. Thus, a detailed description of the operation and components of a WLAN is not provided herein. However, various aspects of the invention are not limited to use with a WLAN, much less an 802.11 compliant WLAN.

In various embodiments, the computer readable instructions provided on the mobile device will allow the user to select the language that the user would like to the complete the consent forms in. This ensures that the user is able to understand the documents that he or she is attesting consent to. In various embodiments, the language selection is made from central computing system or from the mobile device. In some embodiments, the user may indicate language selection such that computer readable instructions provide that forms are generated in user's pre-selected language prior to transmission to the mobile device. In other embodiments, computer readable instructions provide that forms are generated and transmitted to the mobile device where the user may then select the desired language by for example, clicking an icon, choosing from a drop-down, or any other means of indicating a selection.

Various embodiments provide that the forms or documents are visually presented to the individual user on one of the plurality of mobile devices. In one embodiment of the system, the user can read and review (502a) the forms via the visual display on the mobile device. In one embodiment of the system, as shown in FIG. 5A, the user is validated prior to the user reading and reviewing the forms. Some embodiments employ computer readable instructions that provide, for example visual prompts, pop-up text, or dialogue boxes that provide additional explanation or clarification regarding the forms and the information presented to the user. The user can also edit data and input data (502b) into the form via an input means such as a keyboard, keypad, or touch screen. In some embodiments, the computer readable instructions on the mobile device can be configured to support voice input from the user.

In various exemplary embodiments, the computer readable instructions also provide that the forms may be provided to a user audibly. Specifically, a user is provided audible instructions that guide the user through inputting information and providing consent. Audio instructions may also provide clarification or further explanation regarding completing forms that may assist the user in providing informed consent. In various embodiments, audio instructions are provided in a plurality of languages such that a user may select the language that he or she would prefer to receive instructions. In various embodiments, the user may request that the audio instructions are repeated in whole or in part. In some embodiments, the user may also control the speed in which the audio instructions are provided allowing the audio delivery to be slowed to increase user comprehension.

In various embodiments, the user may be presented with multiple documents to review and consent to or the user may be presented with a single document comprising multiple pages of information. In an exemplary embodiment, the user may click, tap, swipe, scroll or otherwise navigate through the documents to go forward or backward within a single document with multiple pages or between a plurality of documents. In some embodiments the user may be required to affix an electronic signature at certain specified points on the form before the document will advance.

In other embodiments, the computer readable instructions mobile device may allow the user to flag or otherwise mark any areas of the form that the user would like assistance with or additional information to complete. In some embodiments, flagging the form may immediately send a notification to the central computing system, alerting someone, such as office staff or other personnel, to offer assistance to the user. In other embodiments, flagging may serve as a bookmark to mark an area that the user needs to return to complete. In exemplary embodiments, the user may be provided an alert to notify him or her of incomplete information or sections that need to be complete prior to submission. Some embodiments may prevent the user from moving on to new pages, sections or documents until incomplete sections have been completed.

Various embodiments provide computer readable instructions that allow for regular backup of the mobile device. In an exemplary embodiment, the contents of the mobile device are saved at consistent time intervals to temporary storage. Providing regular backup allows for the most recent file to be recalled in the event of sudden loss of power to the mobile device. In some embodiments, the data file is temporarily stored on the mobile device and can be recovered. In some embodiments the data file is temporarily stored via a cloud computing system. In some embodiments, the data file is synchronized with the central computing system and is temporarily stored on the central computing system.

In various embodiments, upon review and attestation of consent (502c) on all required forms or documents, the completed (502d) forms are submitted (502e) from the mobile device. Upon submission, the documents are transmitted back (503) to the central computing system (101) via the secure wireless communication network (103).

In an exemplary embodiment, when the data is submitted from the mobile device, it is encrypted for transmission and then readable at the central computing system. When the data files are synchronized such that all data input entered via the mobile device has been transmitted to the central computing system, the central computing system is complete with a duplicate of the information that submitted by the user via the mobile device. When all data files have been synchronized, the data may be stored via a storage means and purged from the mobile device.

In some embodiments, authorized personnel can review completed documents using the central computing system. In other embodiments, the software allows the documents to be scanned for completeness and accuracy. In one embodiment, the completed consent document is stored onsite. In other embodiments, the completed documents are transferred via secure transmission for secure, off-site storage.

In various embodiments, computer readable instructions provide that the documents are marked with a time and date stamp upon completion. Some embodiments provide that the documents are time and date stamped when the user affixes a signature, submits the documents to the central computer, or when the central computing system receives the documents. The timestamp that is affixed to the document may appear on the face of the document or may also be electronically encoded in the document metadata. In various embodiments, the timestamp is associated with the electronic signature as a means of validating date and time of consent. In additional embodiments, the timestamp allows the document to be filed and traced for reference.

In some embodiments, consent forms require input from multiple individuals. When input from multiple individuals is required, some embodiments may require that each individual providing input, such as a signature attesting consent, will be provided with a single mobile device such that each user will use the same device to complete form and provide consent. In some embodiments, a first user may complete all forms, providing consent and then the forms may be reset to allow a second user to provide consent where required. In various embodiments, upon completion, the first user will be prompted to transfer the mobile device to the second user and upon completion, the second user may be prompted to submit documents to end the session. In a case where more than two users are required to input data, the process may be repeated until all required signatures have been obtained. In other embodiments, where a form requires input form multiple users, for example, a first user may only move to complete a second form only after a first form has been completed by all users.

In another exemplary embodiment where input is required from multiple users, each user has his or her own mobile device to provide input. In an embodiment where multiple devices for multiple users is employed, the documents may be shared using a cloud computing document sharing services, (e.g., similar to Google Docs). In various embodiments, multiple users may view and provide consent on forms simultaneously.

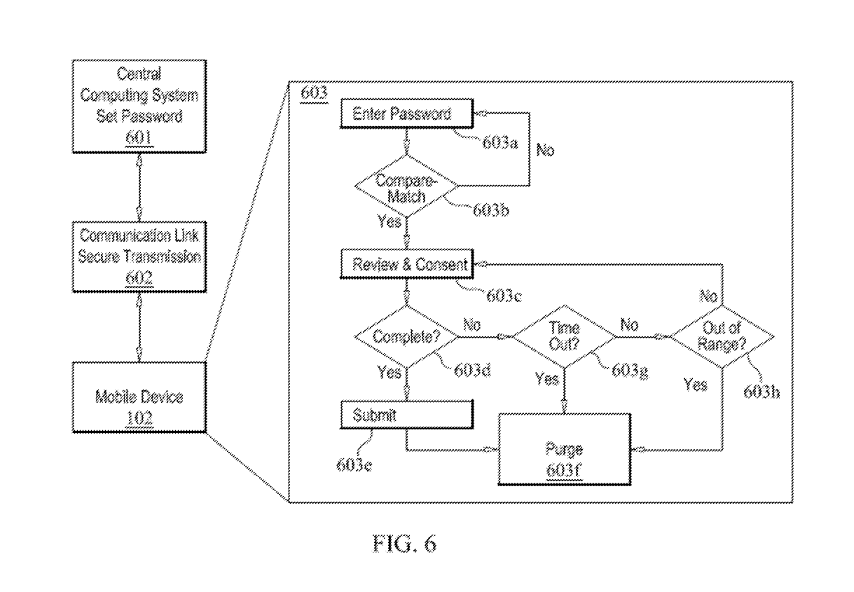

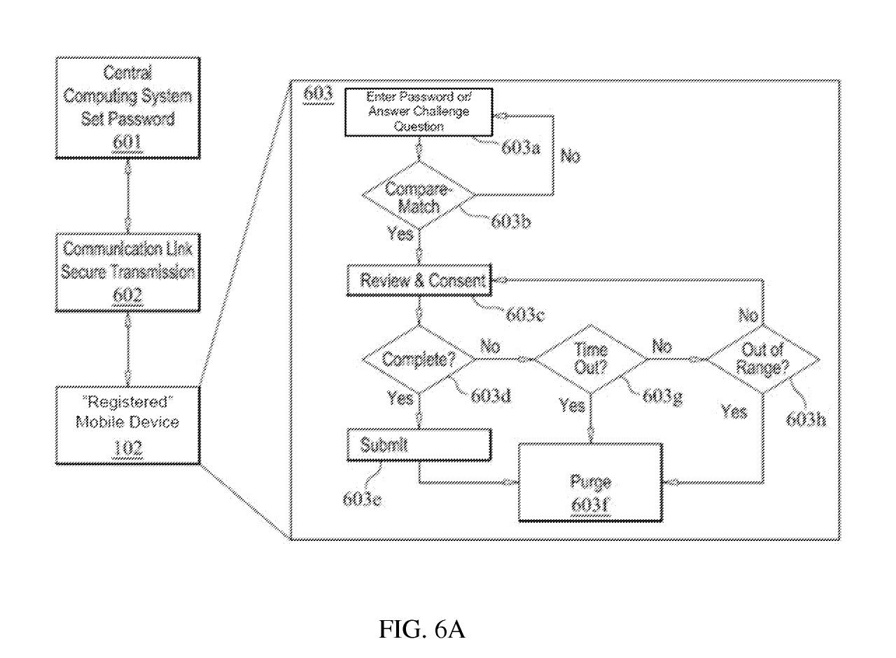

FIG. 6 illustrates an additional embodiment of the consent system using computer readable instructions that provide a security module to ensure that personal information is protected. One embodiment requires the use of personal credentials such as a personal login, PIN, or password to access documents. In some embodiments, personal credentials may be set through a software module, designed to provide secure access to data. The software module may be available through the central computing system, the mobile devices or through a secure web-interface. In various embodiments, the unique user credentials may be set from the central computing system (601) and then required to access forms on the mobile device (603a). In one embodiment, as shown in FIG. 6A, if the password is not entered, the user is prompted to answer a challenge question, such as for example, their zip code, phone number or random data from the form. Passwords entered on the mobile device are compared to the preset password (603b). Only if the passwords match will the user have access to review and provide consent (603c) on the forms. In some embodiments, the system may be “locked,” denying user access, after a set number of failed attempts to enter the correct password. In some embodiments, the mobile device can be registered as shown in 102 of FIG. 6A, where the device has a unique identifier that the central computer can recognize and transmit and receive data to and from it. The unique identifier can be a unique number, code or encryption, digital certificate or the like that causes the central computer to recognize it as an approved device to transmit and receive data to and from it.

In other embodiments, user credentials may be set through a secure web portal and required to access documents on the mobile device. Passwords and credentials may be a combination of alphanumeric characters that are selected by the use or become known to the user such that the user has exclusive access to his or her personal account. Still other embodiments may employ other credentials to access secure information such as a unique value assigned to the user, a biometric input (e.g., finger print scan), or any other identifier that allows the user secure access to forms via the mobile device. The requirement of user credentials to access forms ensures that the user is granted access to only the unique combination of forms requiring his or her consent as well as ensures that any personal information remains private and secure.

Other exemplary embodiments may provide that the mobile device itself is assigned a unique identifier that can be associated with a specific user. The software used in conjunction with the system may map the unique user forms to a specific mobile device such that once the documents have been mapped, only the specified user can access the device with a unique password or code.

In various embodiments, the software instructions on the mobile devices are equipped with additional security measures. In one embodiment, after completion (603d) the user may “submit” (603e) the authorized documents from the mobile device through a secure transmission (602) to the central computing system. After the submission is confirmed, all personal data may be immediately cleared or otherwise permanently deleted (6030 from the memory of the mobile device. In some embodiments, the user may receive notification that the mobile device will be purged of all data after confirming submission of signed documents and in other embodiments, the purging may occur without notice.

In some embodiments, when purging occurs the user's personal or sensitive data, such as name, address, telephone number, social security, case or file number, credit card number, criminal history, medical history, etc. is deleted from the mobile device. In other embodiments, in addition to personal information pertaining to a particular user, the purging module will also delete each complete form provided to the user, including background or static data, such as header information, general instructions, guidelines, disclaimers, consent statements, etc. In various embodiments, the user will be assigned a unique identification code that will correlate the user with the user's consent forms. In some embodiments, the unique identification code may be randomly generated and assigned, while in some embodiments, the code may be based on an internal filing algorithm. In some embodiments, all data is purged with the exception of the unique user code.

In various embodiments, the computer readable instructions on the mobile device may incorporate a timer to monitor the amount of time the user has to complete the assigned forms and documents. In some embodiments, the user may be given a limited amount of time (603g) to compete the forms. The time may begin when the user provides security credentials to the mobile device allowing access to the assigned forms. In various embodiments, the timing device may provide a countdown indicating the remaining time to complete the forms. Additional exemplary embodiments provide that the timing device may provide a warning to the user at various predetermined intervals. For example, the user may be allotted 20 min to complete the assigned forms and warnings may appear at 15 min remaining, 10 min remaining, 5 min remaining, 2 min remaining, and 1 min remaining. The time notifications may be adjusted and may include a combination of occasional “pop-up” notifications and an ongoing countdown (e.g., pop-up notifications for the first 15 min and an ongoing countdown for the last 5 min).

In various embodiments, computer readable instructions provide that data is purged or deleted from the mobile device at the conclusion of a user session. In an exemplary embodiment of the purging algorithm, the user may select a “submit” button to signify completion of the authorization process. Once the user submits the completed forms to the central computing system, a notification acknowledging receipt of the completed documents by the central computing system may be sent to the mobile device. In one embodiment, the user may be asked to manually confirm the end of the session by, for example, responding to an “end session now?” prompt. In another embodiment, the user may be provided with an indication that the session will automatically end in a set amount of time (e.g., 30 seconds). Upon completion of the session, one embodiment provides that the user is provided notice that his or her personal information will be permanently deleted from the mobile device. In another embodiment, the user's personal information may be deleted without notification to the user.

In yet another embodiment, the computer readable instructions provide that data is purged if the allotted time for a user session expires. Specifically, in various embodiments, a user may be provided with a limited amount of time to read and provide consent for the documents provided. In embodiments where a timing module is employed, the purging module may be engaged if the user fails to complete and submit the forms within the time period provided. In some embodiments, when the timing module indicates that time has expired, the user may be provided with a prompt that may allow the user to extend the amount of time required to complete the consent forms. For example, a user prompt may provide “do you need more time?” or “are you still there?” in order to assess whether the user is still actively interacting with the mobile device. In an exemplary embodiment the user may be provided with an additional amount of time in which to respond to the prompt (e.g., 10 seconds). In an embodiment where the user is still engaged with the mobile device, the user may indicate his or her continued involvement and the timing module may be reset to allow the user additional time (e.g., 10 minutes) to complete the consent form process. In another embodiment, the user may fail to respond to the prompt within a set amount of time or indicate that no additional time is desired to complete the consent forms, thereby ending the user session. In an embodiment where no response is received within the set time or the user indicates that no additional time is required, the purging module will be employed. In some embodiments, notice of the purging process may be provided via the mobile device while other embodiments may provide that no notice is provided to the mobile device. In some embodiments the purging process will begin after a period of time has elapsed (e.g., 20 seconds) after the time to enter a response has expired or after the user indicates that no additional time is required, while other embodiments may provide that the purging process begins immediately upon expiration of the time to enter a response or immediately upon the receipt of the user indicating that no additional time is required to complete forms. In some embodiments, the user may manually end the session by submitting the forms upon completion. In some embodiments the user manually ends the session without completing the forms. In various embodiments, when the session has ended, whether the session has timed out or was ended manually, computer readable instructions provide that personal information is purged or deleted from the mobile device.

In another embodiment the system may provide additional security by limiting the range of the mobile device to a specified distance (603h). Limiting the range of the device, for example by restricting the transmission range of the network signal, may protect personal data in the event the mobile device is stolen. In an exemplary embodiment, the device is limited to the range of the Wi-Fi connection. In the exemplary embodiment where the mobile device is taken beyond the signal boundaries, the user may be notified with for example with an alarm such as an audible notification, or a visual notification such as warning message or a visual flashing indicator. If the device is moved beyond the Wi-Fi range, the computer readable instructions will provide that the mobile device will automatically be cleared of all personal data.

In some embodiments computer readable instructions provide that the device is “locked” to prevent any use of the mobile device if the mobile device loses connection with the network signal. In an embodiment where the system is locked, it may be necessary to reset the mobile device where the device is cleaned of all personal information and is restored to a state such that no personal information remains on the device. In one embodiment, a device that is mistakenly removed beyond the preset limits will require that the user forms be resent from the central computing system to the mobile device.

In various embodiments, the mobile device includes a tracking device, such as a Global Positioning System (GPS). In an exemplary embodiment, if a mobile device is removed beyond a predetermined range, the GPS system may be activated. Activation of the GPS may allow for the proper recovery of the mobile device in order to maintain mobile device inventory.

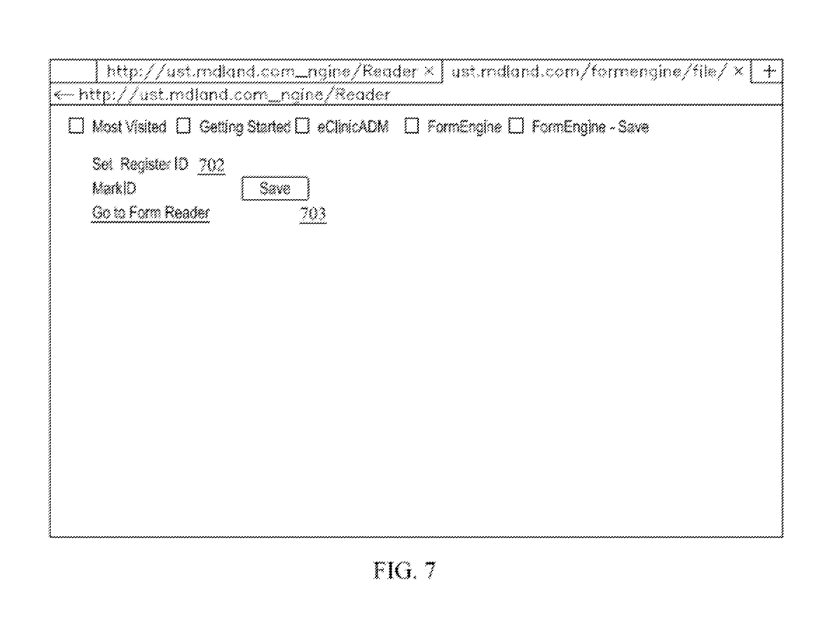

FIG. 7 provides in illustrative embodiment of a screen that the user may be provided with to set or enter a password. In various embodiments the screen is accessible via a web-interface (701). In some embodiments the user login screen may be provided through computer readable instructions such a software program with a security module for allowing a user secure access. In various embodiments, the user may first set a user identification and/or password (702) using a login page. Upon entry, the user may be prompted to “save” the login information (703). The saved user login information can be associated with the user and/or the user information stored in the user's electronic data file. In other embodiments, the user will be presented with a login screen to enter his or her stored, pre-set user identification and/or password. The computer readable instructions may allow the user access to the user's personal documents, such as consent forms upon entry of a user identification and/or password that matches the pre-set.

In one embodiment, multiple users may access personal information simultaneously. The central computing system supports pushing unique documents corresponding to a unique user to each of multiple mobile devices. In this exemplary embodiment, multiple users can access their personal documents on independent mobile devices. For example, document set A, is transferred to mobile device A, where user A can enter his or her unique password to acknowledge and consent to documents. Similarly, document set B, is transferred to mobile device B, where user B can enter his or her unique password to acknowledge and consent to documents. In this exemplary embodiment, document set A may contain 3 documents and document set B may contain 5 documents requiring consent. Mobile device A may be a tablet device and mobile device B may be a laptop computing device. Password A may been assigned based on the device whereas password B may have been preset by the user. Both user A and user B may access document sets A and B, simultaneously from devices A and B respectively.

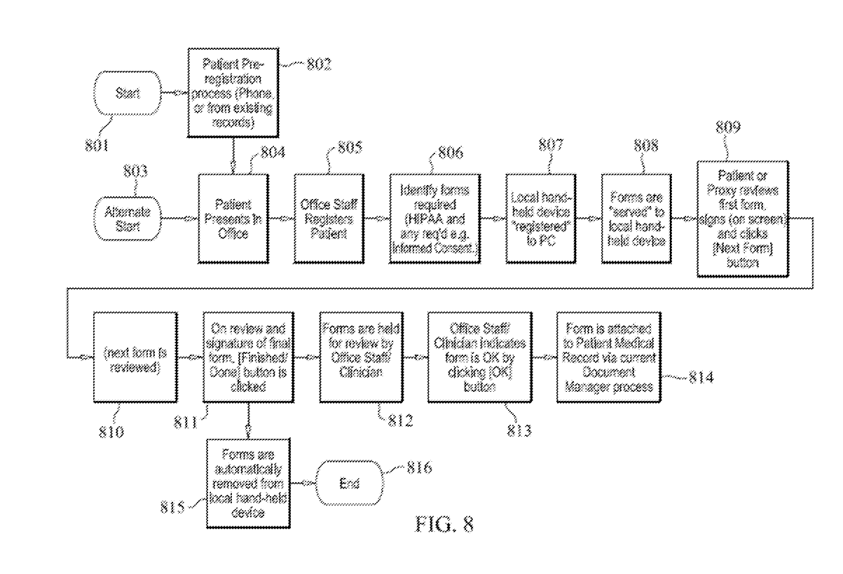

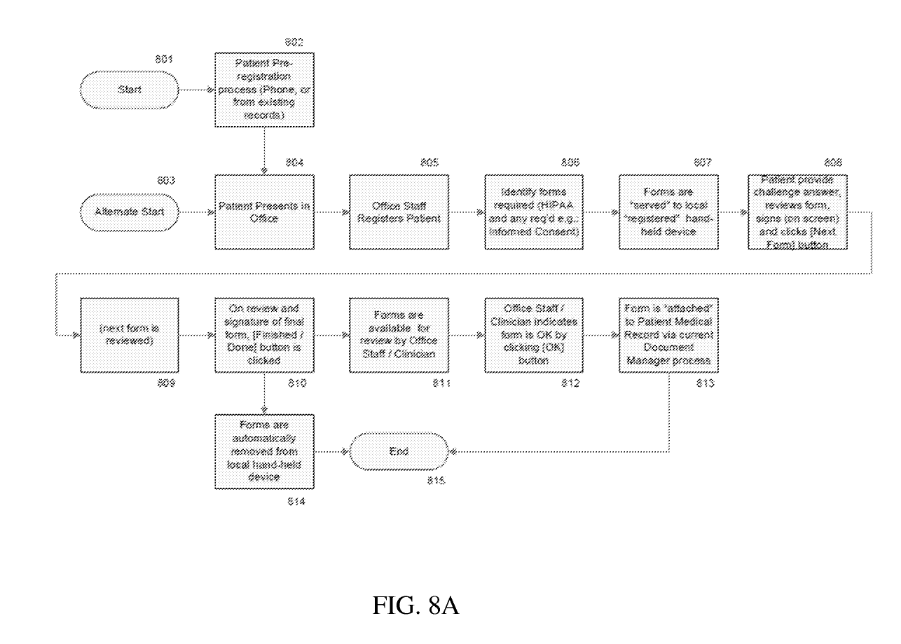

FIG. 8 provides an exemplary embodiment of a method of obtaining consent in a clinical environment. In this embodiment, the user pre-registers for services prior to arriving onsite for services. The pre-registration process may involve entering information such as name, address and phone number in order to establish a user profile. The pre-registration process may allow the user to create a password for accessing account information in the future. Additionally, the pre-registration process may request that the user provide other information as deemed by the process to expedite onsite registration. For one example, the pre-registration process may allow the user to complete medical history documents or provide information regarding the upcoming onsite visit.

In another embodiment, the user has not completed the pre-registration process and the user is registered onsite. In some embodiments, office staff may register the user or in other embodiments the user may use computing systems onsite to register himself. After completing the registration process, the appropriate consent forms can be generated. The consent forms may be generated based on the specific needs of the user. The forms that are generated may be based on information provided during the user's registration process, other information that may be available in a user's history, or the particular reason for the office visit. For example, in a medical treatment facility (e.g., hospital, clinic, etc.), the generated consent forms may also include forms that comply with any regulations for medical treatment (e.g., HIPPA compliant documents).

In one embodiment a local hand held device is first registered to a personal computer. In an alternative embodiment, as shown in FIG. 8A, this step is not required.

In a particular embodiment, a mobile device is then assigned to the user. The process of assigning the device to the user may include computer logic that allows syncing the device to the central computing system to enable a transfer of the customized consent forms that the user is required to authorize. In other embodiments, the user may have to set or enter a password, pin or other personal identification that the user will have to use to securely access customized forms via the mobile device.

In the exemplary embodiment, forms are then transmitted via a secure digital connection to the user's mobile device. The user may access the forms for review. In some embodiments, the user may access the forms on the mobile device by entering a password, pin, or other personal identification. In various embodiments, forms may be provided via secure user email. In some embodiments, access to forms is not provided via a user's personal email or other third party account. The user may be provided with a single form to provide consent or a plurality of forms for attestation of consent. The user may read and provide answers to the forms as required. Upon reaching the end of a form, the user affixes his or her signature to the form. The user is then provided with an additional form to review and consent until the user reaches the last document in his or her queue of forms.

In various embodiments, the forms are completed when the user affixes a signature to the form. The signature of attestation of consent could be in the form of a handwritten signature using an appropriate writing tool on a touch screen or the entry of a personal authorization code or key to validate document. Once a form has been completed and authorized, the next form in the user's queue is made available for review and consent. Once all forms in the queue have been completed, the completed documents are submitted back to the central computing system. In an exemplary embodiment, the record of the user's forms is purged from the mobile device.

In one embodiment, upon completion of all forms, the user transmits the completed forms back to the central computing system. Upon submitting the forms, the files are then deleted from the mobile device.

In an exemplary embodiment, the forms are available for review by the office staff via the central computing device. In another embodiment, the completed forms may be available for review on another secure device, such as another secure computer or mobile system, designated for reviewing completed documents by authorized personnel. Upon review, the completed electronic forms may be included in the user's secure electronic file. In some embodiments, the completed forms may be purged from the computing system or mobile device used for review after the form has been appropriately filed. It will be apparent to those skilled in the art that various modifications and variations can be made to various embodiments described herein without departing from the spirit or scope of the teachings herein. Thus, it is intended that various embodiments cover other modifications and variations of various embodiments within the scope of the present teachings.

What is claimed is:

1. A system for obtaining electronic consent from a user, the system comprising:
a central computing system comprising logic for executing computer readable instruction to cause the central computing system to send and receive electronic data, the central computing system comprising a processing unit, a memory component, a data storage component, a visual display and a means for data input;
a mobile computing device comprising logic for executing computer readable instruction to cause the mobile computing device to send and receive electronic data to and from the central computing system, the mobile device comprising a visual display and a means for data input including a signature; and
a purging module of the central computing system and/or mobile computing device comprising logic for purging some or all data from the mobile device on signing the mobile device and transmitting some or all data from the mobile device to the central computing system.

2. A system for obtaining electronic consent from a user comprising:
a central computing system capable of sending and receiving electronic data, wherein the central computing system comprises a processing unit, a memory component, a data storage component, a visual display and a means for data input, further wherein the computing system comprises logic for executing a computer readable instruction module;
a plurality of mobile computing devices, capable of sending and receiving electronic data, wherein each of the mobile devices includes a visual display, an audio output means and a means for data input, further wherein the mobile devices comprise logic for executing computer readable instruction modules;
a secure communication means for electronically transmitting data between the central computing system and each of the plurality of mobile devices, further wherein the secure communication means has a limited range for transmitting data; and
a plurality of computer readable instruction modules executable in the central computing system and the plurality of mobile devices such that data can be shared between the central computing system and the plurality of mobile devices, further wherein at least one of the computer readable instruction modules is a security module providing that user data is purged from the mobile device.

3. A system for obtaining consent according to claim 2, wherein the secure communication means for transmitting data between the central computing system and each of the mobile devices is a Wi-Fi connection.

4. A system for obtaining electronic consent according to claim 2, wherein at least one of the computer readable instruction modules provides customizable consent forms, wherein the customizable consent form is customized for the individual user.

5. A system for obtaining consent according to claim 4, wherein the secure communication means for transmitting data between the central computing system and each of the plurality of mobile devices allows the customizable consent forms to be transmitted to a mobile device and a completed consent form to be returned to the central computing system.

6. A system for obtaining electronic consent according to claim 2, wherein the security module provides secure access to data on the central computing system and on the plurality of mobile devices, further wherein access is granted to a user's personal information on a mobile device by entry of a password or PIN matching a preset password or PIN.

7. A system for obtaining electronic consent according to claim 2, wherein the data storage of the central computing system is an internal storage component, an onsite storage component, or a cloud based storage component.

8. A system for obtaining electronic consent according to claim 4, wherein the computer readable instruction modules provide customizable consent forms that are available in multiple languages, such that the user may select a preferred language to complete the consent forms on the mobile device.

9. A system for obtaining electronic consent according to claim 2, wherein the data are forms that are viewable on the visual display of the mobile device and editable through the input means of the mobile device.

10. A system for obtaining electronic consent according to claim 2, wherein the visual display is a touch screen such that the touch screen is capable of visual display as well as use as a data input means.

11. A system for obtaining electronic consent according to claim 2, wherein data is purged from the mobile device at the end of each user session or when the mobile device is beyond the communication range of the secure communication means.

12. A system for obtaining electronic consent according to claim 2, wherein a computer readable instruction modules comprise a timer function, wherein the timer function is set to provide a limited amount of time for a user session on the mobile device.

13. A system for obtaining electronic consent according to claim 12, wherein data is purged from the mobile device when the time for the user session on the mobile device has expired.

14. A system for obtaining electronic consent according to claim 6, wherein data is purged from the mobile device if after a set number of attempts, the password does not match a preset password.

15. A computer based system for obtaining electronic consent comprising:
a central computing system capable of sending and receiving electronic data, wherein the central computing system comprises a processing unit, a memory component, a data storage component, a visual display and a means for data input, further wherein the computing system comprises logic for executing a computer readable instruction module;
a plurality of mobile computing devices, capable of sending and receiving electronic data, wherein each of the mobile devices includes a visual display, an audio output means and a means for data input, further wherein the mobile devices comprise logic for executing computer readable instruction modules;
a secure communication means for electronically transmitting data between the central computing system and each of the plurality of mobile devices, further wherein the secure communication means is a WiFi connection having a limited range for transmitting data; and
a plurality of computer readable instruction modules executable in the central computing system and the plurality of mobile devices such that data can be shared between the central computing system and the plurality of mobile devices, further wherein at least one of the computer readable instruction modules is a security module providing that user data is purged from the mobile device.

16. A computer based system for obtaining electronic consent according to claim 15, wherein the central computing system is a computer readable storage medium storing logic for executing computer readable instructions, when executed by a computer, cause the computer to generate a customizable consent form, transmit the consent form to a plurality of mobile devices, display the form on the mobile device, receive and record user input using the mobile device, transmit the consent form back to a central computing system, store data using a data storage component.

17. A computer based system for obtaining electronic consent according to claim 16, wherein at least one of the computer readable instruction modules provides a customizable consent forms, wherein the customizable consent form is customized for the individual user and is visible to the user via the mobile device.

18. A computer based system for obtaining electronic consent according to claim 16, wherein the security module provides secure access to data on the central computing system and on the plurality of mobile devices, further wherein access is granted to a user's personal information on a mobile device by entry of a password or PIN matching a preset password or PIN.

19. A system for obtaining electronic consent according to claim 18, wherein data is purged from the mobile device if after a set number of attempts, the password does not match a preset password.

20. A computer based system for obtaining electronic consent according to claim 16, wherein the data storage of the central computing system is an internal storage component, an onsite storage component, or a cloud based storage component.

21. A computer based system for obtaining electronic consent according to claim 17, wherein the computer readable instruction modules provide customizable consent forms that are available in multiple languages, such that the user may select a preferred language to complete the consent forms on the mobile device.

22. A computer based system for obtaining electronic consent according to claim 16, wherein the data are forms that are viewable on the visual display of the mobile device and editable through the input means of the mobile device.

23. A computer based system for obtaining electronic consent according to claim 16, wherein the visual display is a touch screen such that the touch screen is capable of visual display as well as use as a data input means.

24. A computer based system for obtaining electronic consent according to claim 16, wherein data is purged from the mobile device at the end of each user session or when the mobile device is beyond the communication range of the secure communication means.

25. A computer based system for obtaining electronic consent according to claim 16, wherein computer readable instruction modules comprise a timer function, wherein the timer function is set to provide a limited amount of time for a user session on the mobile device.

26. A computer based system for obtaining electronic consent according to claim 25, wherein data is purged from the mobile device when the time for the user session on the mobile device has expired.

27. A network based system for obtaining electronic consent
a central computing system capable of sending and receiving electronic data, wherein the central computing system comprises a processing unit, a memory component, a data storage component, a visual display and a means for data input, further wherein the computing system comprises logic for executing a computer readable instruction module;
a plurality of mobile computing devices, capable of sending and receiving electronic data, wherein each of the mobile devices includes a visual display, audio output and a means for data input, further wherein the mobile devices comprise logic for executing computer readable instruction modules;
a secure communication means for electronically transmitting data between the central computing system and each of the plurality of mobile devices, further wherein the secure communication means has a limited range for transmitting data; and
a plurality of computer readable instruction modules executable in the central computing system and the plurality of mobile devices such that data can be shared between the central computing system and the plurality of mobile devices, further wherein at least one of the computer readable instruction modules is a security module providing that user data is purged from the mobile device.

28. A network based system for obtaining consent according to claim 27, wherein the secure communication means for transmitting data between the central computing system and each of the mobile devices is a Wi-Fi or Bluetooth connection.

29. A network based system for obtaining electronic consent according to claim 27, wherein at least one of the computer readable instruction modules provides a customizable consent form, wherein the customizable consent form is customized for the individual user.

30. A network based system for obtaining consent according to claim 29, wherein the secure communication means for transmitting data between the central computing system and each of the plurality of mobile devices allows the customizable consent forms to be transmitted to a mobile device and a completed consent form to be returned to the central computing system.

31. A network based system for obtaining electronic consent according to claim 27, wherein the security module provides secure access to data on the central computing system and on the plurality of mobile devices, further wherein access is granted to a user's personal information on a mobile device by entry of a password or PIN matching a preset password or PIN.

32. A network based system for obtaining electronic consent according to claim 27, wherein the data storage of the central computing system is an internal storage component, an onsite storage component, or a cloud based storage component.

33. A network based system for obtaining electronic consent according to claim 29, wherein the computer readable instruction modules provide customizable consent forms that are available in multiple languages, such that the user may select a preferred language to complete the consent forms on the mobile device.

34. A network based system for obtaining electronic consent according to claim 27, wherein the data are forms that are viewable on the visual display of the mobile device and editable through the input means of the mobile device.

35. A network based system for obtaining electronic consent according to claim 27, wherein the visual display is a touch screen such that the touch screen is capable of visual display as well as use as a data input means.

36. A network based system for obtaining electronic consent according to claim 27, wherein data is purged from the mobile device at the end of each user session or when the mobile device is beyond the communication range of the secure communication means.

37. A network based system for obtaining electronic consent according to claim 27, wherein a computer readable instruction module comprising a timer function, wherein the timer function is set to provide a limited amount of time for a user session on the mobile device.

38. A network based system for obtaining electronic consent according to claim 37, wherein data is purged from the mobile device when the time for the user session on the mobile device has expired.

39. A network based system for obtaining electronic consent according to claim 31, wherein data is purged from the mobile device if after a set number of attempts, the password does not match a preset password.

40. A method for obtaining user consent comprising steps of:
providing a central computing system and a plurality of mobile devices, wherein the central computing system and the plurality of mobile devices are coupled through a secure electronic communication means, such that data can be transmitted and received between the central computing system and each of the plurality of mobile devices;
providing a plurality of computer readable instruction modules on the central computing system and the plurality of mobile devices such that data can be shared between the central computing means and the plurality of mobile devices;
creating customized data forms that are customized to an individual user, wherein the customized data forms are created using a computer readable instruction module on the central computing system;
transmitting the customized data forms from the central computing system through the secure electronic communication means to the plurality of mobile devices;
granting the user secure access to the customized data forms from a mobile device, wherein secure access is provided through a computer readable instruction modules providing security to the data;
providing a display screen and a data input means on the mobile device to allow the user to review the customized data forms, edit data and attest consent;
providing a plurality of audible or visual alerts to the user through a computer readable instruction module;
transmitting the completed customized data forms from the plurality of mobile devices back to the central computing system;
reviewing the completed customized data forms;
storing the completed customized data forms in a secure electronic file;
purging the mobile device of personal data.

41. A method for obtaining consent according to claim 40, wherein the secure communication means for transmitting data is a Wi-Fi connection, having a limited transmission range.

42. A method for obtaining consent according to claim 40, wherein granting the user secure access to the customized data forms on the plurality of mobile devices requires that the user enter a password or PIN that matches a preset password or PIN.

43. A method for obtaining consent according to claim 40, wherein the customized data forms are available in a multiple languages and further wherein the language the customized data form is displayed is a language selected from the multiple languages available.

44. A method of obtaining consent according to claim 40, wherein the customized data forms contain multiple pages and further wherein the user can navigate though the multiple pages of the customized consent form to review, edit, bookmark, or attest consent.

45. A method of obtaining consent according to claim 40, wherein data is purged from the mobile device after the completed data forms are transmitted back to the central computing device.

46. A method of obtaining consent according to claim 41 wherein data is purged from the mobile device when mobile device is moved beyond the transmission range of the communication means.

47. A method of obtaining consent according to claim 40 wherein reviewing the completed forms is done by an authorized personnel or by a computer readable instruction modules.

48. A method of obtaining consent according to claim 40 wherein the completed forms are stored in a storage means onsite or stored in a cloud storage means.

49. A method obtaining electronic consent according to claim 40, wherein a computer readable instruction modules comprise a timer function, wherein the timer function is set to provide a limited amount of time for a user session on the mobile device.

50. A method of obtaining electronic consent according to claim 49, wherein data is purged from the mobile device when the time for the user session on the mobile device has expired.

51. A method of obtaining consent according to claim 40, wherein the plurality of alerts may indicate incomplete data in the forms.

52. A method of obtaining consent according to claim 49, wherein the plurality of alerts may indicate a limited amount of time for a user session on the mobile device.

53. A method for obtaining patient consent comprising steps of:
providing a central computing system and a plurality of mobile devices, wherein the central computing system and the plurality of mobile devices are coupled through a secure electronic communication means, such that data can be transmitted and received between the central computing system and each of the plurality of mobile devices, further wherein the secure electronic communication means has a limited transmission range;
creating customized data forms that are customized to an individual user, wherein the customized data forms are created using a computer readable instruction modules on the central computing system, further wherein the customized data forms may provide that some forms are pre-populated with data specific to a user;
transmitting the customized data forms from the central computing system through the secure electronic communication means to the plurality of mobile devices;
granting the user secure access to the customized data forms from a mobile device, wherein secure access is provided through a computer readable instruction modules providing security to the data;
providing a display screen and a data input means on the mobile device to allow the user to review the customized data forms, edit data or attest consent, further wherein the display screen is a touch screen such that the user can input data using the display screen;
providing a computer readable instruction modules that provide a time limit on reviewing the customized forms, editing the data or attesting consent, further wherein periodic audible or visual alerts are provided to the user to advise the user of the remaining time, further wherein the user may be prompted for action if time expires prior to the user completing the customized data forms;
transmitting the completed customized data forms from the plurality of mobile devices through the secure electronic communication means back to the central computing system;
reviewing the completed customized data forms, wherein the review of the completed customized data forms is performed by an authorized personnel;
storing the completed forms in a secure electronic file, wherein the secure storage means may be onsite or cloud based storage;
purging the mobile device of personal data, wherein the mobile device is purged after completed data forms are transmitted back to the central computing system, if the plurality of mobile devices is removed beyond the transmission range of the communication means, or if the time expires prior to the user completing the customized data forms and the user does not take appropriate action to extend the amount of time to complete the customized data forms.
